(19) United States
(12) Patent Application Publication
(10) Pub. No.: US 2025/0344257 A1
(43) Pub. Date: Nov. 6, 2025

(54) RANDOM ACCESS PROCESSING METHOD AND APPARATUS, TERMINAL, AND NETWORK SIDE DEVICE

(71) Applicant: VIVO MOBILE COMMUNICATION CO., LTD., Dongguan (CN)

(72) Inventors: Zhipeng LIN, Dongguan (CN); Kun YANG, Dongguan (CN); Yitao MO, Dongguan (CN); Yong WANG, Dongguan (CN); Wei JIANG, Dongguan (CN); Rakesh TAMRAKAR, Dongguan (CN); Zichao JI, Dongguan (CN)

(21) Appl. No.: 19/273,168

(22) Filed: Jul. 18, 2025

Related U.S. Application Data
(63) Continuation of application No. PCT/CN2024/071903, filed on Jan. 12, 2024.

(30) Foreign Application Priority Data
Jan. 19, 2023 (CN) 202310059320.3

(51) Int. Cl. H04W 74/0833; H04B 7/06; H04W 72/21

(52) U.S. Cl. CPC H04W 74/0833; H04B 7/06952; H04W 72/21

(57) ABSTRACT

This application discloses a random access processing method and apparatus, a terminal, and a network side device, and pertains to the field of communication technologies. The random access processing method in embodiments of this application includes: The terminal sends N physical random access channel PRACH repetitions to the network side device, where the N PRACH repetitions are associated with at least two transmission beams, and N is an integer greater than 1. The terminal receives first information from the network side device, where the first information is determined based on the N PRACH repetitions. The terminal determines a target transmission beam in the at least two transmission beams based on the first information, where the target transmission beam is used by the terminal to send target uplink transmission.

### CROSS-REFERENCE TO RELATED APPLICATIONS

This application is a continuation of International Patent Application No. PCT/CN2024/071903, field on Jan. 12, 2024, which claims priority to Chinese Patent Application No. 202310059320.3, filed on Jan. 19, 2023 in China, both of which are incorporated herein by reference in their entireties.

### TECHNICAL FIELD

This application pertains to the field of communication technologies, and specifically relates to a random access processing method and apparatus, a terminal, and a network side device.

### BACKGROUND

In a communication system, a terminal may access a network through a physical random access channel (Physical Random Access Channel, PRACH). For example, in a case of poor PRACH coverage, the terminal may select PRACH repetition (repetition) transmission, to improve reliability of random access. Currently, the terminal usually sends a plurality of PRACH repetitions on an uplink beam (beam) determined based on a synchronization signal block (Synchronization Signal Block, SSB), and after receiving a random access response, performs a subsequent uplink transmission operation based on the uplink beam.

### SUMMARY

Embodiments of this application provide a random access processing method and apparatus, a terminal, and a network side device.

According to a first aspect, a random access processing method is provided, including:

A terminal sends N physical random access channel PRACH repetitions to a network side device, where the N PRACH repetitions are associated with at least two transmission beams, and N is an integer greater than 1;
the terminal receives first information from the network side device, where the first information is determined based on the N PRACH repetitions; and
the terminal determines a target transmission beam in the at least two transmission beams based on the first information, where the target transmission beam is used by the terminal to send target uplink transmission.

According to a second aspect, a random access processing method is provided, including:
A network side device receives N physical random access channel PRACH repetitions from a terminal, where the N PRACH repetitions are associated with at least two transmission beams, and N is an integer greater than 1;
the network side device determines first information based on the N PRACH repetitions; and
the network side device sends the first information to the terminal, where the first information is used to determine a target transmission beam in the at least two transmission beams, and the target transmission beam is used by the terminal to send target uplink transmission.

According to a third aspect, a random access processing apparatus is provided, including:
a first sending module, configured to send N physical random access channel PRACH repetitions to a network side device, where the N PRACH repetitions are associated with at least two transmission beams, and N is an integer greater than 1;
a first receiving module, configured to receive first information from the network side device, where the first information is determined based on the N PRACH repetitions; and
a first determining module, configured to determine a target transmission beam in the at least two transmission beams based on the first information, where the target transmission beam is used by a terminal to send target uplink transmission.

According to a fourth aspect, a random access processing apparatus is provided, including:
a second receiving module, configured to receive N physical random access channel PRACH repetitions from a terminal, where the N PRACH repetitions are associated with at least two transmission beams, and N is an integer greater than 1;
a second determining module, configured to determine first information based on the N PRACH repetitions; and
a second sending module, configured to send the first information to the terminal, where
the first information is used to determine a target transmission beam in the at least two transmission beams, and the target transmission beam is used by the terminal to send target uplink transmission.

According to a fifth aspect, a terminal is provided. The terminal includes a processor and a memory. The memory stores a program or an instruction that can be run on the processor. When the program or the instruction is executed by the processor, the steps of the method according to the first aspect are implemented.

According to a sixth aspect, a terminal is provided, including a processor and a communication interface. The communication interface is configured to: send N physical random access channel PRACH repetitions to a network side device, where the N PRACH repetitions are associated with at least two transmission beams, and N is an integer greater than 1; and receive first information from the network side device, where the first information is determined based on the N PRACH repetitions. The processor is configured to determine a target transmission beam in the at least two transmission beams based on the first information, where the target transmission beam is used by the terminal to send target uplink transmission.

According to a seventh aspect, a network side device is provided. The network side device includes a processor and a memory. The memory stores a program or an instruction that can be run on the processor. When the program or the instruction is executed by the processor, the steps of the method according to the second aspect are implemented.

According to an eighth aspect, a network side device is provided, including a processor and a communication interface. The communication interface is configured to receive N physical random access channel PRACH repetitions from a terminal, where the N PRACH repetitions are associated with at least two transmission beams, and N is an integer greater than 1. The processor is configured to determine first information based on the N PRACH repetitions. The communication interface is further configured to send the first information to the terminal, where the first information is used to determine a target transmission beam in the at least two transmission beams, and the target transmission beam is used by the terminal to send target uplink transmission.

According to a ninth aspect, a communication system is provided, including a terminal and a network side device. The terminal may be configured to perform the steps of the random access processing method according to the first aspect, and the network side device may be configured to perform the steps of the random access processing method according to the second aspect.

According to a tenth aspect, a readable storage medium is provided. The readable storage medium stores a program or an instruction. When the program or the instruction is executed by a processor, the steps of the method according to the first aspect or the steps of the method according to the second aspect are implemented.

According to an eleventh aspect, a chip is provided. The chip includes a processor and a communication interface. The communication interface is coupled to the processor. The processor is configured to run a program or an instruction to implement the steps of the method according to the first aspect or the steps of the method according to the second aspect.

According to a twelfth aspect, a computer program/program product is provided. The computer program/program product is stored in a storage medium. The computer program/program product is executed by at least one processor to implement the steps of the method according to the first aspect or the steps of the method according to the second aspect.

In embodiments of this application, the terminal sends the N physical random access channel PRACH repetitions to the network side device, where the N PRACH repetitions are associated with the at least two transmission beams. The terminal receives the first information from the network side device, where the first information is determined based on the N PRACH repetitions. The terminal determines the target transmission beam in the at least two transmission beams based on the first information, where the target transmission beam is used by the terminal to send the target uplink transmission. In this way, in a random access procedure, a plurality of uplink beams can be trained to obtain an optimal target transmission beam, so that a subsequent uplink transmission operation can be performed based on the target transmission beam.

### BRIEF DESCRIPTION OF DRAWINGS

FIG. 1 is a schematic diagram of a network structure to which embodiments of this application are applicable;

FIG. 2 is a schematic flowchart of a random access processing method according to an embodiment of this application;

FIG. 3 is a schematic flowchart of another random access processing method according to an embodiment of this application;

FIG. 4 is a schematic diagram of a structure of a random access processing apparatus according to an embodiment of this application;

FIG. 5 is a schematic diagram of a structure of another random access processing apparatus according to an embodiment of this application;

FIG. 6 is a schematic diagram of a structure of a communication device according to an embodiment of this application;

FIG. 7 is a schematic diagram of a structure of a terminal according to an embodiment of this application; and

FIG. 8 is a schematic diagram of a structure of a network side device according to an embodiment of this application.

### DESCRIPTION OF EMBODIMENTS

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in this specification and the claims, “and/or” represents at least one of connected objects, and a character “/” usually represents an “or” relationship between associated objects.

The term “indication” in the specification and claims of this application may be an explicit indication, or may be an implicit indication. The explicit indication may be understood as that a sender explicitly notifies, in a sent indication, a receiver of an operation that needs to be performed or a request result. The implicit indication may be understood as that a receiver determines based on an indication sent by a sender, and determines, based on a determining result, an operation that needs to be performed or a request result.

It should be noted that technologies described in the embodiments of this application are not limited to a long term evolution (Long Term Evolution, LTE)/LTE-advanced (LTE-Advanced, LTE-A) system, and may be further applied to other wireless communication systems such as code division multiple access (Code Division Multiple Access, CDMA), time division multiple access (Time Division Multiple Access, TDMA), frequency division multiple access (Frequency Division Multiple Access, FDMA), orthogonal frequency division multiple access (Orthogonal Frequency Division Multiple Access, OFDMA), single-carrier frequency division multiple access (Single-carrier Frequency Division Multiple Access, SC-FDMA), and other systems. The terms “system” and “network” in the embodiments of this application are often used interchangeably. The technologies described can be applied to both the systems and the radio technologies mentioned above as well as to other systems and radio technologies. A new radio (New Radio, NR) system is described in the following description for illustrative purposes, and the NR terminology is used in most of the following description. However, these technologies can alternatively be applied to applications other than an NR system application, such as a 6^{th} generation (6^{th} Generation, 6G) communication system.

As a result, the uplink beam determined in a random access procedure may not be an optimal uplink beam, which leads to poor reliability of uplink transmission of the terminal.

Embodiments of this application provide a random access processing method and apparatus, a terminal, and a network side device, so that a problem of poor reliability of uplink transmission of the terminal can be resolved. Therefore, in embodiments of this application, reliability of uplink transmission of the terminal is improved. In addition, uplink beam training is implemented in the random access procedure. In this way, no additional resource is needed to perform uplink beam training, so that resource utilization is improved.

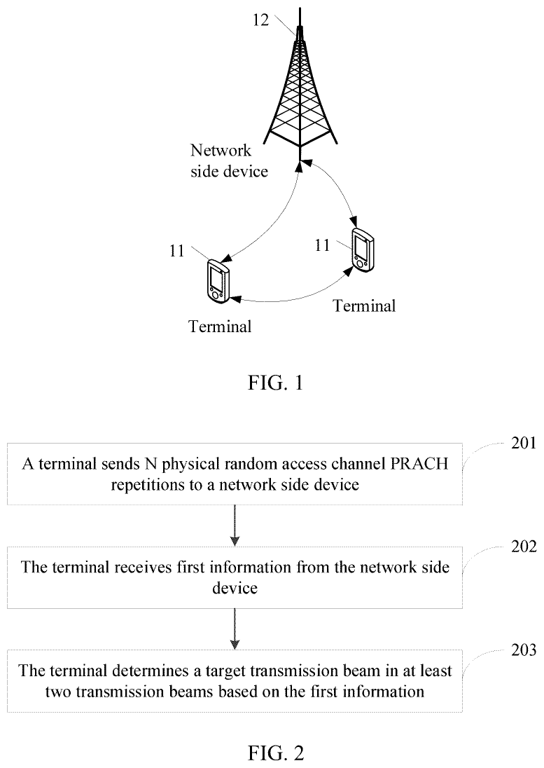

FIG. 1 is a block diagram of a wireless communication system to which the embodiments of this application may be applied. The wireless communication system includes a terminal 11 and a network side device 12. The terminal 11 may be a terminal side device such as a mobile phone, a tablet personal computer (Tablet Personal Computer), a laptop computer (Laptop Computer) or a notebook computer, a personal digital assistant (Personal Digital Assistant, PDA), a palmtop computer, a netbook, an ultra-mobile personal computer (ultra-mobile personal computer, UMPC), a mobile internet device (Mobile Internet Device, MID), an augmented reality (augmented reality, AR)/virtual reality (virtual reality, VR) device, a robot, a wearable device (Wearable Device), vehicle user equipment (Vehicle User Equipment, VUE), pedestrian user equipment (Pedestrian User Equipment, PUE), a smart home (a home device with a wireless communication function, such as a refrigerator, a television, a washing machine, or furniture), a game console, a personal computer (personal computer, PC), a teller machine, or a self-service machine. The wearable device includes a smart watch, a smart band, a smart headset, smart glasses, smart jewelry (a smart bangle, a smart bracelet, a smart ring, a smart necklace, a smart anklet, a smart chain, and the like), a smart wrist strap, a smart dress, and the like. It should be noted that a specific type of the terminal 11 is not limited in the embodiments of this application. The network side device 12 may include an access network device or a core network device. The access network device may also be referred to as a radio access network device, a radio access network (Radio Access Network, RAN), a radio access network function, or a radio access network unit. The access network device may include a base station, a wireless local area network (Wireless Local Area Network, WLAN) access point, a wireless fidelity (Wireless Fidelity, Wi-Fi) node, or the like. The base station may be referred to as a NodeB, an evolved NodeB (Evolved NodeB, eNB), an access point, a base transceiver station (Base Transceiver Station, BTS), a radio base station, a radio transceiver, a basic service set (Basic Service Set, BSS), an extended service set (Extended Service Set, ESS), a home NodeB, a home evolved NodeB, a transmitting receiving point (Transmitting Receiving Point, TRP), or another appropriate term in the field. As long as a same technical effect is achieved, the base station is not limited to a specified technical term. It should be noted that, in embodiments of this application, only a base station in an NR system is used as an example, and a specific type of the base station is not limited.

For ease of understanding, some content related to the embodiments of this application is described below.

### 1. Random Access Procedure.

The random access procedure may be a contention-based random access procedure, or may be a non-contention based random access procedure. The random access procedure may be a 4-step random access procedure (also referred to as a Type-1 (Type-1) random access procedure) or a 2-step random access procedure (also referred to as a Type-2 random access procedure).

In a contention 4-step random access (RACH) process, a terminal first sends a message 1 (Msg 1) to a network, including a preamble (preamble). After detecting the preamble, a network side device sends a message 2 (Msg 2)/random access response (Random Access Response, RAR) message, including a number of the preamble detected by the network side device and an uplink radio resource allocated to the UE to send a message 3 (Msg 3). After receiving the Msg 2, the UE acknowledges that at least one of numbers of preambles carried in the Msg 2 is consistent with a number of the preamble sent by the UE, and sends, based on the resource indicated by an RAR, the Msg 3 that includes contention resolution information. After receiving the Msg 3, the network side device sends a message 4 (Msg 4) that includes the contention resolution information. The UE receives the Msg 4, and acknowledges that the contention resolution information is consistent with that sent by the UE in the Msg 3, that is, completes 4-step random access.

The network side device includes uplink grant (UL grant) information in the RAR to indicate scheduling information of an Msg 3 physical uplink shared channel (Physical Uplink Shared Channel, PUSCH), and includes information such as a random access preamble identifier (RACH preamble ID), a temporary cell radio network temporary identifier (Temporary Cell Radio Network Temporary Identifier, TC-RNTI), and a timing advance (Timing Advance, TA). If the network side device does not receive the Msg 3 PUSCH, Msg 3 PUSCH repetition transmission may be scheduled on a physical downlink control channel (Physical Downlink Control Channel, PDCCH) scrambled by the TC-RNTI.

For a contention random access procedure, different UEs randomly select preambles for transmission. As a result, different UEs may select a same preamble for sending on a same time-frequency radio resource (PRACH occasion (PRACH Occasion, RO) resource), which may be understood as a preamble conflict of the UEs. In this case, different UEs receive a same RAR, and different UEs perform transmission of the Msg 3 PUSCH based on scheduling information in UL grant of the RAR. A related technology does not support Msg 3 PUSCH repetition transmission, and the network side device can decode, on one Msg 3 PUSCH scheduling resource, only a PUSCH (including the contention resolution information) sent by one UE. Therefore, the network side device includes, in the Msg 4, the contention resolution information received in the Msg 3. If the contention resolution information in the Msg 4 received by the UE matches the contention resolution information sent by the UE in the Msg 3 PUSCH, the UE considers that contention resolution succeeds. If the contention resolution information in the Msg 4 received by the UE does not match the contention resolution information sent by the UE in the Msg 3 PUSCH, it is considered that the contention resolution fails.

If the contention resolution fails, the UE reselects an RACH sending resource, performs PRACH sending, and performs a next random access attempt.

In the 2-step random access (2-step RACH) process, a first step is that the UE sends a message A (Msg A) to the network side device. After receiving the Msg A, the network side device sends a message B (Msg B) to the UE. If the UE does not receive the Msg B within specific time, the UE accumulates a counter for counting Msg A sending times and resends the Msg A. If the counter for counting the Msg A sending times reaches a specific threshold, the UE switches from the 2-step random access procedure to the 4-step random access procedure. The Msg A includes an Msg A preamble part and an Msg A PUSCH part. The preamble part is sent on an RO used for a 2-step RACH, and the PUSCH part is sent on an Msg A PUSCH resource associated with sending of an Msg A preamble and the RO. The Msg A PUSCH resource is a group of PUSCH resources configured relative to each PRACH slot (slot), including a time-frequency resource and a demodulation reference signal (Demodulation Reference Signal, DMRS) resource.

### 2. PRACH Repetition.

To rapidly implement PRACH detection, the third generation partnership project (Third Generation Partnership Project, 3GPP) approves PRACH repetitions corresponding to a standardized single beam in an NR coverage enhancement work item (work item). That is, a terminal may send a plurality of PRACH repetitions in one beam.

Performing PRACH repetition transmission in time domain is a method for improving PRACH coverage. A UE selects the PRACH repetition in a case of poor coverage. In this case, if there is no PRACH repetition, the UE usually needs to perform a plurality of PRACH retransmissions to complete a random access procedure, and a random access delay is excessively long. Improving a random access success rate and reducing the delay of the random access procedure are main objectives of a PRACH repetition feature (feature). When a single beam is used to send a PRACH, joint detection of a plurality of PRACH repetitions can be implemented, to improve a detection success rate. In this case, an uplink single beam used to send the PRACH is usually based on a beam used by an optimal SSB. An actual uplink beam is usually implemented based on the UE. In a random access phase, it is difficult to train an optimal uplink beam. Although an attempt may be performed through PRACH retransmission, a delay may be large. Therefore, a random access processing method in this application is provided.

With reference to the accompanying drawings, the following describes in detail the random access processing method provided in the embodiments of this application by using some embodiments and application scenarios thereof.

Refer to FIG. 2. An embodiment of this application provides a random access processing method. As shown in FIG. 2, the random access processing method includes:

Step 201: A terminal sends N physical random access channel PRACH repetitions to a network side device, where the N PRACH repetitions are associated with at least two transmission beams, and N is an integer greater than 1.

Step 202: The terminal receives first information from the network side device, where the first information is determined based on the N PRACH repetitions.

Step 203: The terminal determines a target transmission beam in the at least two transmission beams based on the first information, where the target transmission beam is used by the terminal to send target uplink transmission.

In this embodiment of this application, the random access processing method may be applied to a contention-based random access procedure, or may be applied to a non-contention-based random access procedure. The transmission beam may be understood as a transmission beam of the terminal, or may be referred to as an uplink beam. The target transmission beam may be understood as an optimal uplink beam determined based on random access procedure training.

Optionally, that the N PRACH repetitions are associated with at least two transmission beams may be understood as that transmission of the N PRACH repetitions is performed at the at least two transmission beams, or may be understood as a quantity of beams for the PRACH repetition, where each PRACH repetition is associated with one transmission beam.

Optionally, the target uplink transmission may be understood as uplink transmission sent by the terminal after the PRACH repetitions. For example, in some embodiments, the target uplink transmission includes at least one of the following:
a message 3;
a message A physical uplink shared channel PUSCH; or
non-PRACH uplink transmission in a radio resource control (Radio Resource Control, RRC) idle state or an inactive state.

The radio resource control (Radio Resource Control, RRC) idle state or the inactive state may be understood as a non-RCC connected state.

In this embodiment of this application, the terminal sends the N physical random access channel PRACH repetitions to the network side device, where the N PRACH repetitions are associated with the at least two transmission beams. The terminal receives the first information from the network side device, where the first information is determined based on the N PRACH repetitions. The terminal determines the target transmission beam in the at least two transmission beams based on the first information, where the target transmission beam is used by the terminal to send the target uplink transmission. In this way, in a random access procedure, a plurality of uplink beams can be trained to obtain an optimal target transmission beam, so that a subsequent uplink transmission operation can be performed based on the target transmission beam. Therefore, in this embodiment of this application, reliability of uplink transmission of the terminal is improved. In addition, uplink beam training is implemented in the random access procedure. In this way, no additional resource is needed to perform uplink beam training, so that resource utilization is improved.

Optionally, in some embodiments, the N PRACH repetitions belong to at least two PRACH groups.

In this embodiment of this application, the at least two PRACH groups may be obtained through division based on the N PRACH repetitions, and each PRACH group includes at least one PRACH repetition.

Optionally, in some embodiments, a quantity of PRACH groups is specified in a protocol or indicated by the network side device.

It should be understood that the foregoing “indicated by the network side device” may include that the network side device performs indication during initial access, or performs dynamic indication during each random access.

It should be noted that when one PRACH group includes at least two PRACH repetitions, different PRACH repetitions in one PRACH group may be associated with a same transmission beam or different transmission beams. That is, PRACH repetitions in one PRACH group may be transmitted by using a same transmission beam or different transmission beams. When all PRACH repetitions in one PRACH group are associated with a same transmission beam, that the N PRACH repetitions are associated with at least two transmission beams may be understood as or replaced with that the N PRACH repetitions are associated with at least two PRACH groups.

Optionally, in some embodiments, when the PRACH repetition is a PRACH repetition based on non-contention access (Non-Contention or Contention Free Random Access, CFRA), the quantity of PRACH groups is dynamically indicated by the network side device.

In this embodiment of this application, the foregoing “dynamically indicated” means that each time random access is performed, the network side device performs indication. That is, each time random access is performed, the quantity of PRACH groups is dynamically indicated. Because the network side device performs dynamic indication, the quantity of PRACH groups may be flexibly indicated based on a current status of the terminal, to improve flexibility of configurations of PRACH repetition grouping.

For example, in some embodiments, dynamic indication may be performed in a PDCCH order (PDCCH order) or a handover command (handover command).

Optionally, in some embodiments, the quantity of PRACH groups obtained through division based on the N PRACH repetitions or a quantity of transmission beams associated with the N PRACH repetitions is a target quantity, and the target quantity satisfies at least one of the following:
a product of the target quantity and a quantity of candidate synchronization signal blocks SSBs associated with the PRACH repetition is less than or equal to a first preset value;
the target quantity is determined based on a band in which the PRACH repetition is transmitted;
the target quantity is determined based on N; or
the target quantity is determined based on a quantity of repetitions of the target uplink transmission.

Optionally, the first preset value may be understood as a predetermined value or a fixed value, for example, 64.

Optionally, when the target quantity depends on the band, for a frequency range 1 (Frequency range 1, FR 1), it may be defined that the target quantity may not exceed 8. For an FR 2, it may be defined that the target quantity may not exceed 64.

Optionally, if the target quantity is determined based on N, the target quantity may be determined according to the following Table 1.

TABLE 1

| N | Target quantity |
|---|---|
| 2 | 2 |
| 4 | 2 |
| 8 | 4 |

Optionally, if the target quantity is determined based on the quantity of repetitions of the target uplink transmission, the target quantity may be determined based on a correspondence between the quantity of repetitions of the target uplink transmission and the target quantity. For example, it is assumed that a quantity of PRACH group indicated to the UE by the network side device is x, and a quantity of Msg 3 repetition transmissions is y. It may be specified that x=max {1, floor (y/2)}

Optionally, in some embodiments, at least one of N, the quantity of PRACH groups obtained through division based on the N PRACH repetitions, the quantity of transmission beams associated with the N PRACH repetitions, a quantity of PRACH repetitions included in each PRACH group, or a quantity of PRACH repetitions corresponding to each transmission beam is configured based on an SSB.

In this embodiment of this application, the following parameters of PRACH repetition transmission configurations corresponding to different SSB resources are different:
a total quantity of PRACH repetitions (that is, N);
the quantity of different PRACH groups;
the quantity of PRACH repetitions included in each PRACH group; and
the quantity of PRACH repetitions corresponding to each transmission beam.

For example, the network side device may determine, based on a width of an SSB beam, a quantity of narrower beams corresponding to the SSB. For example, a wide SSB corresponds to a plurality of narrow SSB beams.

For example, in some embodiments, the quantity of beams for the PRACH repetition (BeamNumberPerSSB list), that is, BeamNumberPerSSBList, may be configured in a RACH-ConfigCommon information element (Information element, IE) of a PRACH resource for configuring the PRACH repetition. At the same time, it is defined that a sequence BeamNumberPerSSB may be configured differently for different SSBs.

In this embodiment of this application, related configurations of PRACH repetition transmission are configured for different SSB resources, so that flexibility and pertinence of PRACH repetition transmission can be improved. Therefore, it can be further ensured that an optimal transmission beam can be obtained through training in a random access phase, to improve reliability of performing an uplink transmission operation on the target transmission beam.

Optionally, in some embodiments, the first information may include a target random access response or downlink control information (Downlink Control Information, DCI) for scheduling the target random access response.

In this embodiment of this application, the first information is used to indicate at least one of the following:
a target PRACH group, where the target PRACH group includes a part or all of the at least two PRACH groups obtained through division based on the N PRACH repetitions, and each PRACH group includes at least one PRACH repetition; or
at least one of the at least two transmission beams.

In other words, in this embodiment of this application, the target PRACH group and/or the at least one of the at least two transmission beams may be explicitly or implicitly indicated by using the target RAR or the DCI for scheduling the target RAR. Manners for performing implicit indication include but are not limited to the following manners:
performing implicit indication by using different random access RNTIs (Random Access RNTIs, RA-RNTIs);
performing implicit indication by using different control resource sets (Control resource sets, CORESETs);
performing implicit indication by using different search spaces (Search Spaces, SSs); and
performing implicit indication by using different ROs.

In this embodiment of this application, PRACH repetitions are grouped, and the network side device needs to indicate only one or more PRACH groups to the UE. For example, eight PRACH repetitions may be divided into four groups, and each group includes two consecutive PRACH repetitions. A network receives the four groups of PRACH repetitions, and may indicate a group with best signal quality to the UE. In this case, only 2 bits are required to indicate one of the four groups. In this way, signaling overheads can be reduced.

Optionally, in some embodiments, grouping may be performed based on the quantity of beams for the PRACH repetition.

Optionally, in some embodiments, when the first information is used to indicate the target PRACH group and the target PRACH group includes one PRACH group, that the terminal determines a target transmission beam in the at least two transmission beams based on the first information includes:
The terminal determines the target PRACH group based on the first information; and
the terminal determines a transmission beam associated with a first PRACH repetition in the target PRACH group as the target transmission beam, where
the first PRACH repetition is specified in the protocol or indicated by the network side device.

In this embodiment of this application, the first PRACH repetition may be any PRACH repetition in the target PRACH group (group) or a PRACH repetition predefined in the target PRACH group. For example, the first PRACH repetition is a 1^{st} PRACH repetition in the target PRACH group.

For example, there are eight PRACH repetitions, which are divided into four PRACH groups. If the network side device indicates, by using the RAR, that a 2^{nd} PRACH group is an optimal PRACH group (namely, the target PRACH group), subsequent uplink transmission uses an uplink beam corresponding to a 1^{st} PRACH repetition in the 2^{nd} PRACH group.

Optionally, in some embodiments, when the first information is used to indicate the target PRACH group and the target PRACH group includes M PRACH groups, that the terminal determines a target transmission beam in the at least two transmission beams based on the first information includes:
The terminal determines the M PRACH groups based on the first information;
the terminal determines a first PRACH group, where the first PRACH group is one of the M PRACH groups; and
the terminal determines a transmission beam associated with a second PRACH repetition in the first PRACH group as the target transmission beam, where
M is an integer greater than 1, and the second PRACH repetition is specified in the protocol, indicated by the network side device, or independently determined by the terminal.

In this embodiment of this application, the M PRACH groups may be all of the at least two PRACH groups or a PRACH group that meets a preset condition, for example, first M PRACH groups that are arranged in descending order of measurement results.

Optionally, the second PRACH repetition may be any PRACH repetition in the first PRACH group or a PRACH repetition predefined in the first PRACH group. For example, the second PRACH repetition is a 1^{st} PRACH repetition in the target PRACH group.

It should be understood that, in this embodiment of this application, when a plurality of PRACH groups are indicated to the terminal, a beam used for subsequent uplink transmission (namely, the target transmission beam) may be a beam used for any PRACH transmission in a specific PRACH group indicated by the network side device, or a beam used for a predefined PRACH transmission in a specific PRACH group.

Optionally, in some embodiments, the M PRACH groups are indicated in an order of priority in the first information.

In this embodiment of this application, the M PRACH groups may include corresponding indication information in the first information, and that the M PRACH groups are indicated in an order of priority in the first information may be understood as an arrangement order of the indication information in the first information. For example, a 1^{st} indicated PRACH group may be a PRACH group with a highest priority or a lowest priority.

It should be understood that, in another embodiment, indication may alternatively not be performed in the order of priority, and a priority corresponding to each PRACH group is directly further indicated. In this embodiment of this application, performing indication in the order of priority can reduce indication bit overheads of a priority.

Optionally, in some embodiments, the priority is determined based on received signal strength and/or received signal quality of the PRACH repetition.

For example, if a PRACH repetition in a PRACH group has highest received signal strength and/or best received signal quality, it is determined that the PRACH group has a highest priority.

In this case, the UE may determine, based on the order of the received indication information corresponding to the PRACH groups, to use a transmission beam for a PRACH repetition in which PRACH group, or transmission beams for PRACH repetitions in which PRACH groups to perform a subsequent uplink transmission operation.

Optionally, in some embodiments, that a terminal sends N physical random access channel PRACH repetitions to a network side device includes:

The terminal sends the N physical random access channel PRACH repetitions to the network side device based on a beam pattern, where
the beam pattern is used to indicate an association relationship between the transmission beams and the N PRACH repetitions, and the beam pattern is specified in the protocol or indicated by the network side device.

In this embodiment of this application, one or more beam patterns may be defined for a plurality of PRACH repetition. For example, the beam pattern may include 11112222 and 12121212. 11112222 indicates that when there are two beams, one consecutive segment of repetitions corresponds to one beam, and remaining consecutive repetitions correspond to the other beam. 12121212 indicates that the two beams appear alternately.

Optionally, in some embodiments, the quantity of transmission beams associated with the N PRACH repetitions is specified in the protocol or indicated by the network side device.

It should be understood that the foregoing “indicated by the network side device” may include that the network side device performs indication during initial access, or performs dynamic indication during each random access.

For example, in some embodiments, the quantity of beams for the PRACH repetition may be configured in the RACH-ConfigCommon IE configured in the PRACH resource of the PRACH repetition. For example, the following parameter is used to indicate the quantity of beams for the PRACH repetition: totalNumberOfRA-Beams. The parameter may be 1 by default when the parameter is not configured.

In some embodiments, the quantity of beams for the PRACH repetition may alternatively be configured in a FeatureCombinationPreambles IE configured in the PRACH resource of the PRACH repetition. For example, the following parameter is used to indicate the quantity of beams for the PRACH repetition: totalNumberOfRA-Beams. The parameter may be 1 by default when the parameter is not configured.

Optionally, when the PRACH repetition is a PRACH repetition based on non-contention random access, the quantity of transmission beams associated with the N PRACH repetitions is dynamically indicated by the network side device.

In this embodiment of this application, the foregoing “dynamically indicated” means that each time random access is performed, the network side device performs indication. That is, each time random access is performed, the quantity of transmission beams associated with the N PRACH repetitions is dynamically indicated. Because the network side device performs dynamic indication, the quantity of transmission beams associated with the N PRACH repetitions may be flexibly indicated based on the current status of the terminal, to improve flexibility of configurations of the quantity of transmission beams associated with the N PRACH repetitions.

Optionally, in some embodiments, the first information is determined based on received signal strength and/or received signal quality of the N PRACH repetitions.

In this embodiment of this application, that the first information is determined based on received signal strength and/or received signal quality of the N PRACH repetitions may be understood as that the target PRACH group and/or the transmission beam for the PRACH repetition that are/is indicated by the first information is determined based on the received signal strength and/or the received signal quality of the N PRACH repetitions.

Optionally, in some instances, the network side device may indicate the first information based on an arrangement order of the received signal strength of the N PRACH repetitions and/or an arrangement order of the received signal quality of the N PRACH repetitions. For example, an optimal PRACH group and/or an optimal transmission beam are/is first determined, and then are/is indicated by using the first information. The optimal PRACH group and/or the optimal transmission beam means that corresponding received signal strength is optimal and/or corresponding received signal quality is optimal.

Optionally, in some embodiments, the network side device may alternatively determine one or more PRACH groups and/or transmission beams based on a relationship between the received signal strength of the N PRACH repetitions and a received signal strength threshold and/or a relationship between the received signal quality and a received signal quality threshold, and then indicate the one or more PRACH groups and/or transmission beams by using the first information.

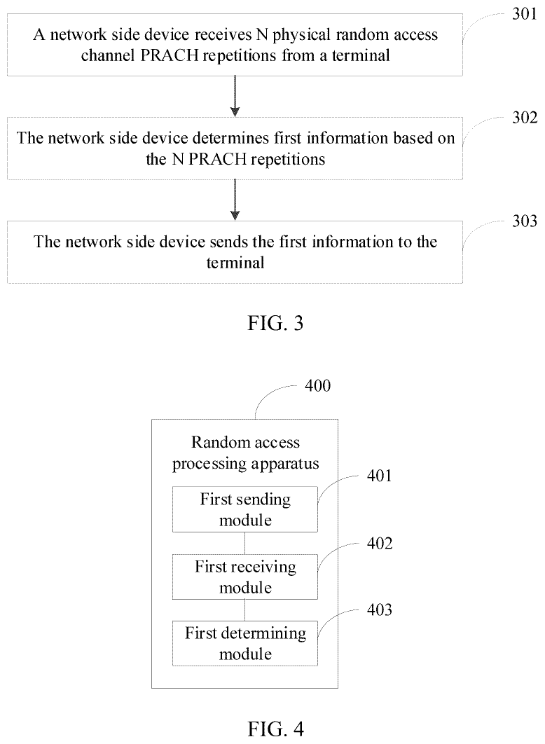

Refer to FIG. 3. An embodiment of this application further provides another random access processing method. As shown in FIG. 3, the random access processing method includes:

Step 301: A network side device receives N physical random access channel PRACH repetitions from a terminal, where the N PRACH repetitions are associated with at least two transmission beams, and N is an integer greater than 1.

Step 302: The network side device determines first information based on the N PRACH repetitions.

Step 303: The network side device sends the first information to the terminal, where the first information is used to determine a target transmission beam in the at least two transmission beams, and the target transmission beam is used by the terminal to send target uplink transmission.

Optionally, a quantity of PRACH groups obtained through division based on the N PRACH repetitions or a quantity of transmission beams associated with the N PRACH repetitions is a target quantity, and the target quantity satisfies at least one of the following:
a product of the target quantity and a quantity of candidate synchronization signal blocks SSBs associated with the PRACH repetition is less than or equal to a first preset value;
the target quantity is determined based on a band in which the PRACH repetition is transmitted;
the target quantity is determined based on N; or
the target quantity is determined based on a quantity of repetitions of the target uplink transmission.

Optionally, at least one of N, the quantity of PRACH groups obtained through division based on the N PRACH repetitions, the quantity of transmission beams associated with the N PRACH repetitions, a quantity of PRACH repetitions included in each PRACH group, or a quantity of PRACH repetitions corresponding to each transmission beam is configured based on an SSB.

Optionally, the N PRACH repetitions belong to at least two PRACH groups.

Optionally, the quantity of PRACH groups is specified in a protocol or indicated by the network side device.

Optionally, when the PRACH repetition is a PRACH repetition based on non-contention access, the quantity of PRACH groups is dynamically indicated by the network side device.

Optionally, the first information includes a target random access response or downlink control information DCI for scheduling the target random access response.

Optionally, the first information is used to indicate at least one of the following:
a target PRACH group, where the target PRACH group includes a part or all of the at least two PRACH groups obtained through division based on the N PRACH repetitions, and each PRACH group includes at least one PRACH repetition; or
at least one of the at least two transmission beams.

Optionally, when the first information is used to indicate the target PRACH group and the target PRACH group includes M PRACH groups, the M PRACH groups are indicated in an order of priority in the first information, and M is an integer greater than 1.

Optionally, the priority is determined based on received signal strength and/or received signal quality of the PRACH repetition.

Optionally, that a network side device receives N physical random access channel PRACH repetitions from a terminal includes:

The network side device receives the N physical random access channel PRACH repetitions from the terminal based on a beam pattern, where
the beam pattern is used to indicate an association relationship between the transmission beams and the N PRACH repetitions, and the beam pattern is specified in the protocol or indicated by the network side device.

Optionally, the quantity of transmission beams associated with the N PRACH repetitions is specified in the protocol or indicated by the network side device.

Optionally, when the PRACH repetition is a PRACH repetition based on non-contention random access, the quantity of transmission beams associated with the N PRACH repetitions is dynamically indicated by the network side device.

Optionally, the target uplink transmission includes at least one of the following:
a message 3;
a message A physical uplink shared channel PUSCH; or
non-PRACH uplink transmission in a radio resource control RRC idle state or an inactive state.

Optionally, that the network side device determines first information based on the N PRACH repetitions includes:

The network side device determines the first information based on received signal strength and/or received signal quality of the N PRACH repetitions.

The random access processing method provided in embodiments of this application may be performed by a random access processing apparatus. In embodiments of this application, that the random access processing apparatus performs the random access processing method is used as an example to describe the random access processing apparatus provided in embodiments of this application.

Refer to FIG. 4. An embodiment of this application further provides a random access processing apparatus. As shown in FIG. 4, the random access processing apparatus 400 includes:
a first sending module 401, configured to send N physical random access channel PRACH repetitions to a network side device, where the N PRACH repetitions are associated with at least two transmission beams, and N is an integer greater than 1;
a first receiving module 402, configured to receive first information from the network side device, where the first information is determined based on the N PRACH repetitions; and
a first determining module 403, configured to determine a target transmission beam in the at least two transmission beams based on the first information, where the target transmission beam is used by a terminal to send target uplink transmission.

Optionally, a quantity of PRACH groups obtained through division based on the N PRACH repetitions or a quantity of transmission beams associated with the N PRACH repetitions is a target quantity, and the target quantity satisfies at least one of the following:
a product of the target quantity and a quantity of candidate synchronization signal blocks SSBs associated with the PRACH repetition is less than or equal to a first preset value;
the target quantity is determined based on a band in which the PRACH repetition is transmitted;
the target quantity is determined based on N; or
the target quantity is determined based on a quantity of repetitions of the target uplink transmission.

Optionally, at least one of N, a quantity of PRACH groups obtained through division based on the N PRACH repetitions, a quantity of transmission beams associated with the N PRACH repetitions, a quantity of PRACH repetitions included in each PRACH group, or a quantity of PRACH repetitions corresponding to each transmission beam is configured based on an SSB.

Optionally, the N PRACH repetitions belong to at least two PRACH groups.

Optionally, a quantity of PRACH groups is specified in a protocol or indicated by the network side device.

Optionally, when the PRACH repetition is a PRACH repetition based on non-contention access, a quantity of PRACH groups is dynamically indicated by the network side device.

Optionally, the first information includes a target random access response or downlink control information DCI for scheduling the target random access response.

Optionally, the first information is used to indicate at least one of the following:
a target PRACH group, where the target PRACH group includes a part or all of the at least two PRACH groups obtained through division based on the N PRACH repetitions, and each PRACH group includes at least one PRACH repetition; or
at least one of the at least two transmission beams.

Optionally, when the first information is used to indicate the target PRACH group and the target PRACH group includes one PRACH group, the first determining module 403 is specifically configured to:
determine the target PRACH group based on the first information; and
determine a transmission beam associated with a first PRACH repetition in the target PRACH group as the target transmission beam, where
the first PRACH repetition is specified in a protocol, indicated by the network side device, or independently determined by the terminal.

Optionally, when the first information is used to indicate the target PRACH group and the target PRACH group includes M PRACH groups, the first determining module 403 is specifically configured to:
determine the M PRACH groups based on the first information;
determine a first PRACH group, where the first PRACH group is one of the M PRACH groups; and
determine a transmission beam associated with a second PRACH repetition in the first PRACH group as the target transmission beam, where
M is an integer greater than 1, and the second PRACH repetition is specified in a protocol, indicated by the network side device, or independently determined by the terminal.

Optionally, the M PRACH groups are indicated in an order of priority in the first information.

Optionally, the priority is determined based on received signal strength and/or received signal quality of the PRACH repetition.

Optionally, the first sending module 401 is specifically configured to:
send the N physical random access channel PRACH repetitions to the network side device based on a beam pattern, where
the beam pattern is used to indicate an association relationship between the transmission beams and the N PRACH repetitions, and the beam pattern is specified in a protocol or indicated by the network side device.

Optionally, a quantity of transmission beams associated with the N PRACH repetitions is specified in a protocol or indicated by the network side device.

Optionally, when the PRACH repetition is a PRACH repetition based on non-contention random access, a quantity of transmission beams associated with the N PRACH repetitions is dynamically indicated by the network side device.

Optionally, the target uplink transmission includes at least one of the following:
a message 3;
a message A physical uplink shared channel PUSCH; or
non-PRACH uplink transmission in a radio resource control RRC idle state or an inactive state.

Optionally, the first information is determined based on received signal strength and/or received signal quality of the N PRACH repetitions.

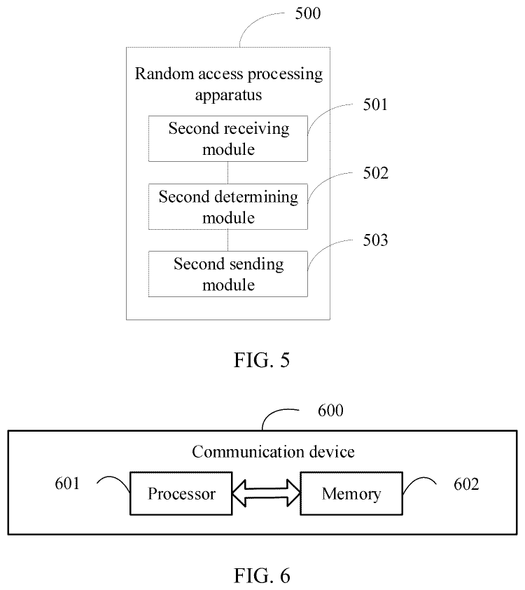

Refer to FIG. 5. An embodiment of this application further provides a random access processing apparatus. As shown in FIG. 5, the random access processing apparatus 500 includes:
a second receiving module 501, configured to receive N physical random access channel PRACH repetitions from a terminal, where the N PRACH repetitions are associated with at least two transmission beams, and N is an integer greater than 1;
a second determining module 502, configured to determine first information based on the N PRACH repetitions; and
a second sending module 503, configured to send the first information to the terminal, where
the first information is used to determine a target transmission beam in the at least two transmission beams, and the target transmission beam is used by the terminal to send target uplink transmission.

Optionally, a quantity of PRACH groups obtained through division based on the N PRACH repetitions or a quantity of transmission beams associated with the N PRACH repetitions is a target quantity, and the target quantity satisfies at least one of the following:
a product of the target quantity and a quantity of candidate synchronization signal blocks SSBs associated with the PRACH repetition is less than or equal to a first preset value;
the target quantity is determined based on a band in which the PRACH repetition is transmitted;
the target quantity is determined based on N; or
the target quantity is determined based on a quantity of repetitions of the target uplink transmission.

Optionally, at least one of N, a quantity of PRACH groups obtained through division based on the N PRACH repetitions, a quantity of transmission beams associated with the N PRACH repetitions, a quantity of PRACH repetitions included in each PRACH group, or a quantity of PRACH repetitions corresponding to each transmission beam is configured based on an SSB.

Optionally, the N PRACH repetitions belong to at least two PRACH groups.

Optionally, a quantity of PRACH groups is specified in a protocol or indicated by the network side device.

Optionally, when the PRACH repetition is a PRACH repetition based on non-contention access, a quantity of PRACH groups is dynamically indicated by the network side device.

Optionally, the first information includes a target random access response or downlink control information DCI for scheduling the target random access response.

Optionally, the first information is used to indicate at least one of the following:
a target PRACH group, where the target PRACH group includes a part or all of the at least two PRACH groups obtained through division based on the N PRACH repetitions, and each PRACH group includes at least one PRACH repetition; or
at least one of the at least two transmission beams.

Optionally, when the first information is used to indicate the target PRACH group and the target PRACH group includes M PRACH groups, the M PRACH groups are indicated in an order of priority in the first information, and M is an integer greater than 1.

Optionally, the priority is determined based on received signal strength and/or received signal quality of the PRACH repetition.

Optionally, the second receiving module 501 is specifically configured to receive the N physical random access channel PRACH repetitions from the terminal based on a beam pattern, where
the beam pattern is used to indicate an association relationship between the transmission beams and the N PRACH repetitions, and the beam pattern is specified in a protocol or indicated by the network side device.

Optionally, a quantity of transmission beams associated with the N PRACH repetitions is specified in a protocol or indicated by the network side device.

Optionally, when the PRACH repetition is a PRACH repetition based on non-contention random access, a quantity of transmission beams associated with the N PRACH repetitions is dynamically indicated by the network side device.

Optionally, the target uplink transmission includes at least one of the following:
a message 3;
a message A physical uplink shared channel PUSCH; or
non-PRACH uplink transmission in a radio resource control RRC idle state or an inactive state.

Optionally, the second determining module 502 is specifically configured to determine the first information based on received signal strength and/or received signal quality of the N PRACH repetitions.

The random access processing apparatus in embodiments of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a network attached storage (Network Attached Storage, NAS), or the like. This is not specifically limited in embodiments of this application.

The random access processing apparatus provided in embodiments of this application can implement processes implemented in the method embodiments of FIG. 2 and FIG. 3, and achieve a same technical effect. To avoid repetition, details are not described herein again.

Optionally, as shown in FIG. 6, an embodiment of this application further provides a communication device 600, including a processor 601 and a memory 602. The memory 602 stores a program or an instruction that can be run on the processor 601. When the program or the instruction is executed by the processor 601, the steps in the foregoing random access processing method embodiments can be implemented, and a same technical effect can be achieved. To avoid repetition, details are not described herein again.

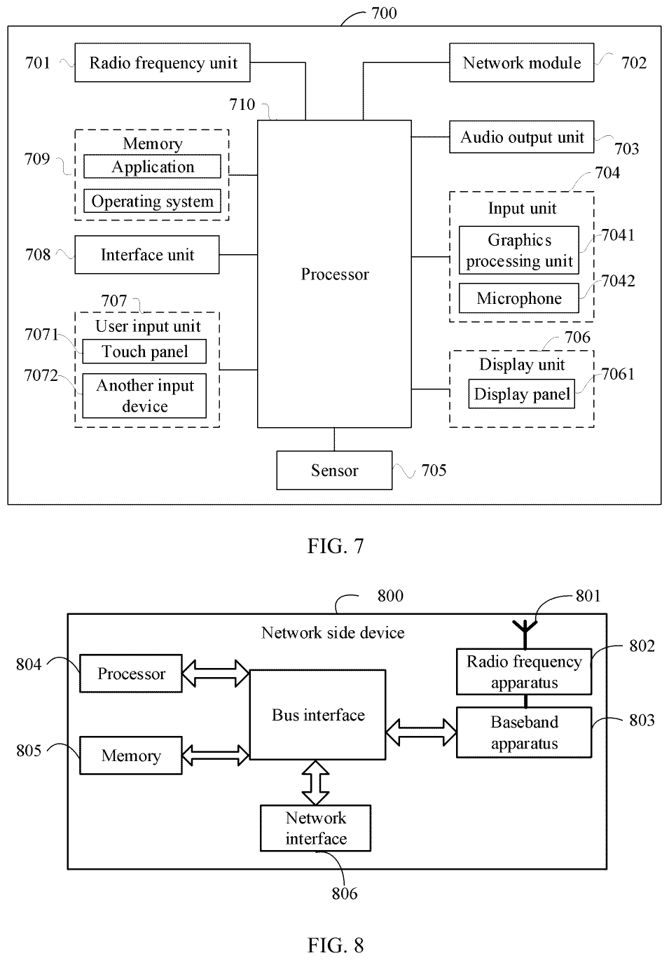

An embodiment of this application further provides a terminal, including a processor and a communication interface. The communication interface is configured to: send N physical random access channel PRACH repetitions to a network side device, where the N PRACH repetitions are associated with at least two transmission beams, and N is an integer greater than 1; and receive first information from the network side device, where the first information is determined based on the N PRACH repetitions. The processor is configured to determine a target transmission beam in the at least two transmission beams based on the first information, where the target transmission beam is used by the terminal to send target uplink transmission. This terminal embodiment corresponds to the foregoing terminal side method embodiment, each implementation process and implementation of the method embodiment can be applied to this terminal embodiment, and a same technical effect can be achieved. Specifically, FIG. 7 is a schematic diagram of a hardware structure of a terminal according to an embodiment of this application.

The terminal 700 includes but is not limited to at least a part of components such as a radio frequency unit 701, a network module 702, an audio output unit 703, an input unit 704, a sensor 705, a display unit 706, a user input unit 707, an interface unit 708, a memory 709, and a processor 710.

A person skilled in the art can understand that the terminal 700 may further include a power supply (such as a battery) that supplies power to each component. The power supply may be logically connected to the processor 710 by using a power supply management system, to implement functions such as charging and discharging management, and power consumption management by using the power supply management system. The terminal structure shown in FIG. 7 constitutes no limitation on the terminal, and the terminal may include more or fewer components than those shown in the figure, or combine some components, or have different component arrangements. Details are not described herein.

It should be understood that in this embodiment of this application, the input unit 704 may include a graphics processing unit (Graphics Processing Unit, GPU) 7041 and a microphone 7042. The graphics processing unit 7041 processes image data of a static picture or a video obtained by an image capture apparatus (for example, a camera) in a video capture mode or an image capture mode. The display unit 706 may include a display panel 7061, and the display panel 7061 may be configured in a form of a liquid crystal display, an organic light-emitting diode, or the like. The user input unit 707 includes at least one of a touch panel 7071 or another input device 7072. The touch panel 7071 is also referred to as a touchscreen. The touch panel 7071 may include two parts: a touch detection apparatus and a touch controller. The another input device 7072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 701 may transmit the downlink data to the processor 710 for processing. In addition, the radio frequency unit 701 may send uplink data to the network side device. Usually, the radio frequency unit 701 includes but is not limited to an antenna, an amplifier, a transceiver, a coupler, a low noise amplifier, a duplexer, and the like.

The memory 709 may be configured to store a software program or an instruction and various data. The memory 709 may mainly include a first storage area for storing a program or an instruction and a second storage area for storing data. The first storage area may store an operating system, and an application or an instruction required by at least one function (for example, a sound playing function or an image playing function). In addition, the memory 709 may be a volatile memory or a non-volatile memory, or the memory 709 may include a volatile memory and a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchlink dynamic random access memory (Synch link DRAM, SLDRAM), and a direct rambus random access memory (Direct Rambus RAM, DRRAM). The memory 709 in this embodiment of this application includes but is not limited to these memories and any memory of another proper type.

The processor 710 may include one or more processing units. Optionally, an application processor and a modem processor are integrated into the processor 710. The application processor mainly processes an operating system, a user interface, an application, and the like. The modem processor mainly processes a wireless communication signal, for example, a baseband processor. It may be understood that, alternatively, the modem processor may not be integrated into the processor 710.

The radio frequency unit 701 is configured to: send N physical random access channel PRACH repetitions to the network side device, where the N PRACH repetitions are associated with at least two transmission beams, and N is an integer greater than 1; and receive first information from the network side device, where the first information is determined based on the N PRACH repetitions.

The processor 710 is configured to determine a target transmission beam in the at least two transmission beams based on the first information, where the target transmission beam is used by the terminal to send target uplink transmission.

An embodiment of this application further provides a network side device, including a processor and a communication interface. The communication interface is configured to receive N physical random access channel PRACH repetitions from a terminal, where the N PRACH repetitions are associated with at least two transmission beams, and N is an integer greater than 1. The processor is configured to determine first information based on the N PRACH repetitions. The communication interface is further configured to send the first information to the terminal, where the first information is used to determine a target transmission beam in the at least two transmission beams, and the target transmission beam is used by the terminal to send target uplink transmission. This network side device embodiment corresponds to the foregoing network side device method embodiment, each implementation process and implementation of the method embodiment can be applied to this network side device embodiment, and a same technical effect can be achieved.

Specifically, an embodiment of this application further provides a network side device. As shown in FIG. 8, the network side device 800 includes an antenna 801, a radio frequency apparatus 802, a baseband apparatus 803, a processor 804, and a memory 805. The antenna 801 is connected to the radio frequency apparatus 802. In an uplink direction, the radio frequency apparatus 802 receives information through the antenna 801, and sends the received information to the baseband apparatus 803 for processing. In a downlink direction, the baseband apparatus 803 processes information that needs to be sent, and sends processed information to the radio frequency apparatus 802. The radio frequency apparatus 802 processes the received information, and sends processed information through the antenna 801.

In the foregoing embodiment, the method performed by the network side device may be implemented in the baseband apparatus 803. The baseband apparatus 803 includes a baseband processor.

For example, the baseband apparatus 803 may include at least one baseband board. A plurality of chips are disposed on the baseband board. As shown in FIG. 8, one chip is, for example, a baseband processor, and is connected to the memory 805 by using a bus interface, to invoke a program in the memory 805 to perform the operations of the network device shown in the foregoing method embodiment.

The network side device may further include a network interface 806, and the interface is, for example, a common public radio interface (common public radio interface, CPRI).

Specifically, the network side device 800 in this embodiment of this application further includes an instruction or a program that is stored in the memory 805 and that can be run on the processor 804. The processor 804 invokes the instruction or the program in the memory 805 to perform the method performed by the modules shown in FIG. 5, and a same technical effect is achieved. To avoid repetition, details are not described herein again.

An embodiment of this application further provides a readable storage medium. The readable storage medium stores a program or an instruction. When the program or the instruction is executed by a processor, processes in the foregoing random access processing method embodiments can be implemented, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface. The communication interface is coupled to the processor. The processor is configured to run a program or an instruction to implement the processes in the foregoing random access processing method embodiments, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, and the computer program/program product is executed by at least one processor to implement the processes of the foregoing random access processing method embodiments, and a same technical effect can be achieved. To avoid repetition, details are not described herein again.

An embodiment of this application further provides a communication system, including a terminal and a network side device. The terminal is configured to execute the processes in the method embodiments on the terminal side and in FIG. 2, and the network side device is configured to execute the processes in the method embodiments on the network side device side and in FIG. 3. A same technical effect can be achieved. To avoid repetition, details are not described herein again.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the related functions. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. A random access processing method, comprising:
sending, by a terminal, N physical random access channel PRACH repetitions to a network side device, wherein the N PRACH repetitions are associated with at least two transmission beams, and N is an integer greater than 1;
receiving, by the terminal, first information from the network side device, wherein the first information is determined based on the N PRACH repetitions; and
determining, by the terminal, a target transmission beam in the at least two transmission beams based on the first information, wherein the target transmission beam is used by the terminal to send target uplink transmission.

2. The method according to claim 1, wherein a quantity of PRACH groups obtained through division based on the N PRACH repetitions or a quantity of transmission beams associated with the N PRACH repetitions is a target quantity, and the target quantity satisfies at least one of the following:
a product of the target quantity and a quantity of candidate synchronization signal blocks SSBs associated with the PRACH repetition is less than or equal to a first preset value;
the target quantity is determined based on a band in which the PRACH repetition is transmitted;
the target quantity is determined based on N; or
the target quantity is determined based on a quantity of repetitions of the target uplink transmission.

3. The method according to claim 1, wherein at least one of N, a quantity of PRACH groups obtained through division based on the N PRACH repetitions, a quantity of transmission beams associated with the N PRACH repetitions, a quantity of PRACH repetitions comprised in each PRACH group, or a quantity of PRACH repetitions corresponding to each transmission beam is configured based on an SSB.

4. The method according to claim 1, wherein the N PRACH repetitions belong to at least two PRACH groups.

5. The method according to claim 4, wherein a quantity of PRACH groups is specified in a protocol or indicated by the network side device, or
wherein when the PRACH repetition is a PRACH repetition based on non-contention access, a quantity of PRACH groups is dynamically indicated by the network side device.

6. The method according to claim 1, wherein the first information comprises a target random access response or downlink control information DCI for scheduling the target random access response.

7. The method according to claim 1, wherein the first information is used to indicate at least one of the following:
a target PRACH group, wherein the target PRACH group comprises a part or all of the at least two PRACH groups obtained through division based on the N PRACH repetitions, and each PRACH group comprises at least one PRACH repetition; or
at least one of the at least two transmission beams.

8. The method according to claim 7, wherein when the first information is used to indicate the target PRACH group and the target PRACH group comprises one PRACH group, the determining, by the terminal, a target transmission beam in the at least two transmission beams based on the first information comprises:
determining, by the terminal, the target PRACH group based on the first information; and
determining, by the terminal, a transmission beam associated with a first PRACH repetition in the target PRACH group as the target transmission beam, wherein
the first PRACH repetition is specified in a protocol, indicated by the network side device, or independently determined by the terminal,
or, wherein when the first information is used to indicate the target PRACH group and the target PRACH group comprises M PRACH groups, the determining, by the terminal, a target transmission beam in the at least two transmission beams based on the first information comprises:
determining, by the terminal, the M PRACH groups based on the first information;
determining, by the terminal, a first PRACH group, wherein the first PRACH group is one of the M PRACH groups; and
determining, by the terminal, a transmission beam associated with a second PRACH repetition in the first PRACH group as the target transmission beam, wherein
M is an integer greater than 1, and the second PRACH repetition is specified in a protocol, indicated by the network side device, or independently determined by the terminal.

9. The method according to claim 1, wherein the sending, by a terminal, N physical random access channel PRACH repetitions to a network side device comprises:
sending, by the terminal, the N physical random access channel PRACH repetitions to the network side device based on a beam pattern, wherein
the beam pattern is used to indicate an association relationship between the transmission beams and the N PRACH repetitions, and the beam pattern is specified in a protocol or indicated by the network side device.

10. The method according to claim 1, wherein a quantity of transmission beams associated with the N PRACH repetitions is specified in a protocol or indicated by the network side device, or
wherein when the PRACH repetition is a PRACH repetition based on non-contention random access, a quantity of transmission beams associated with the N PRACH repetitions is dynamically indicated by the network side device.

11. A random access processing method, comprising:
receiving, by a network side device, N physical random access channel PRACH repetitions from a terminal, wherein the N PRACH repetitions are associated with at least two transmission beams, and N is an integer greater than 1;
determining, by the network side device, first information based on the N PRACH repetitions; and
sending, by the network side device, the first information to the terminal, wherein
the first information is used to determine a target transmission beam in the at least two transmission beams, and the target transmission beam is used by the terminal to send target uplink transmission.

12. The method according to claim 11, wherein a quantity of PRACH groups obtained through division based on the N PRACH repetitions or a quantity of transmission beams associated with the N PRACH repetitions is a target quantity, and the target quantity satisfies at least one of the following:
a product of the target quantity and a quantity of candidate synchronization signal blocks SSBs associated with the PRACH repetition is less than or equal to a first preset value;
the target quantity is determined based on a band in which the PRACH repetition is transmitted;
the target quantity is determined based on N; or
the target quantity is determined based on a quantity of repetitions of the target uplink transmission.

13. The method according to claim 11, wherein at least one of N, a quantity of PRACH groups obtained through division based on the N PRACH repetitions, a quantity of transmission beams associated with the N PRACH repetitions, a quantity of PRACH repetitions comprised in each PRACH group, or a quantity of PRACH repetitions corresponding to each transmission beam is configured based on an SSB.

14. The method according to claim 11, wherein the N PRACH repetitions belong to at least two PRACH groups.

15. The method according to claim 14, wherein a quantity of PRACH groups is specified in a protocol or indicated by the network side device, or
wherein when the PRACH repetition is a PRACH repetition based on non-contention access, a quantity of PRACH groups is dynamically indicated by the network side device.

16. The method according to claim 11, wherein the first information comprises a target random access response or downlink control information DCI for scheduling the target random access response, or
wherein the first information is used to indicate at least one of the following:
a target PRACH group, wherein the target PRACH group comprises a part or all of at least two PRACH groups obtained through division based on the N PRACH repetitions, and each PRACH group comprises at least one PRACH repetition; or
at least one of the at least two transmission beams.

17. The method according to claim 16, wherein when the first information is used to indicate the target PRACH group and the target PRACH group comprises M PRACH groups, the M PRACH groups are indicated in an order of priority in the first information, and M is an integer greater than 1.

18. The method according to claim 11, wherein the receiving, by a network side device, N physical random access channel PRACH repetitions from a terminal comprises:
receiving, by the network side device, the N physical random access channel PRACH repetitions from the terminal based on a beam pattern, wherein
the beam pattern is used to indicate an association relationship between the transmission beams and the N PRACH repetitions, and the beam pattern is specified in a protocol or indicated by the network side device.

19. A terminal, comprising a processor and a memory, wherein the memory stores a program or an instruction that can be run on the processor, and when the program or the instruction is executed by the processor, the steps of a random access processing method are implemented, the method comprising:
sending, by the terminal, N physical random access channel PRACH repetitions to a network side device, wherein the N PRACH repetitions are associated with at least two transmission beams, and N is an integer greater than 1;
receiving, by the terminal, first information from the network side device, wherein the first information is determined based on the N PRACH repetitions; and
determining, by the terminal, a target transmission beam in the at least two transmission beams based on the first information, wherein the target transmission beam is used by the terminal to send target uplink transmission.

20. A network side device, comprising a processor and a memory, wherein the memory stores a program or an instruction that can be run on the processor, and when the program or the instruction is executed by the processor, the steps of the random access processing method according to claim 11 are implemented.
